(19) United States
(12) Patent Application Publication
(10) Pub. No.: US 2010/0291703 A1
(43) Pub. Date: Nov. 18, 2010

(54) BIOSENSOR

(75) Inventors: Hsin- Fei Meng, Hsinchu (TW); Sheng-Fu Hong, Hsinchu (TW); Yu-Chiang Chao, Hsinchu (TW); Yun-Ru Horng, Hsinchu (TW); Pei-Yu Tsai, Hsinchu (TW); Chia-Ming Yang, Hsinchu (TW)

Correspondence Address: EDWARDS ANGELL PALMER & DODGE LLP, P.O. BOX 55874, BOSTON, MA, 02205, US

(73) Assignee: NATIONAL CHIAO TUNG UNIVERSITY, Hsinchu (TW)

(21) Appl. No.: 12/775,924

(22) Filed: May 7, 2010

(30) Foreign Application Priority Data
May 15, 2009 (TW) 98116112

(51) Int. Cl. G01N 21/76; G01J 1/58; G01N 30/00

(52) U.S. Cl. 436/172; 250/458.1; 250/459.1; 422/69

(57) ABSTRACT

A biosensor applicable to an environment suitable for biosensing is provided, which is a solid-state element for performing detections in an aqueous environment. The biosensor at least includes a biosensing layer, a light-emitting diode and a photodiode. The biosensing layer causes changes in the light-emitting property thereof after absorbing, adsorbing and/or bonding with a biological substance released during in vivo signal transduction in an organism, and the rays of light generated by excitation of the light-emitting diode causes the biosensing layer to emit fluorescence. After the fluorescence is absorbed by the photodiode, it can be converted into an interpretable photocurrent signal. Afterwards, the meaning of the in vivo signal transduction can be understood by interpretation of the photocurrent signal.

### BACKGROUND OF THE INVENTION

1. Field of the Invention

The present invention relates to a biosensor, and more particularly, to a biosensor applicable to a aqueous environment.

2. Description of the Prior Art

A “biosensor” currently refers to an analytic device capable of detecting microconstituents, and the analytical device uses a biosensor element such as an enzyme, an antibody, etc. to convert a variable amount of chemical substance such as glucose, plasma concentration, potassium ion (K⁺) concentration, cholesterol, etc. in a biosystem into a corresponding electronic signal or an optical signal.

However, current biosensors face issues like high prices, bulky volumes and incapability for performing real-time measurements.

In “Method and apparatus for electrochemical detection,” with an issued/published number 1295372 in the Patent Gazette of the Republic of China, a method for quantitatively measuring a fluid sample by applying a potential profile to an electrochemical unit is disclosed.

In “A biosensor for one-hand operation,” with an issued/published number M329421 in the Patent Gazette of the Republic of China, a biosensor is mentioned, but its technical feature is directed to a mechanical structure.

In “Biosensor device using bioactive membrane,” with an issued/published number 1293116 in the Patent Gazette of the Republic of China, the technical feature is the interoperability of electrodes, substrates and a bioactive membrane, but the biosensor is still a conventional biosensor that contains electrodes and substrates

In “Method for reducing measuring bias in amperometric biosensors,” with an issued/published number 1292041 in the Patent Gazette of the Republic of China, the technical feature of the method is directed to amperometric biosensors using an electrode system and a redox electronic medium, but the biosensors are still conventional biosensors that contain electrodes.

In “Biosensor”, with an issued/published number 1290224 in the Patent Gazette of the Republic of China, the technical feature is directed to using a nanoparticle membrane containing oxidoreductase and an electrochemical activator, and the technical field is the investigation on the properties of the nanoparticle membrane. The case does not involve light-emitting diodes or photodiodes.

In a non-patent literature, “Thin film organic photodiodes as integrated detectors for microscale chemiluminescence assays,” Sensors and Acturators B 106, 878 (2005) discloses a low-molecular, organic photodiode structure. In the application of the organic photodiode, a microfluidic tube is first used to introduce a sample fluid, and then the organic photodiode detects fluorescence emitted by the sample fluid.

In “Characterization of an Integrated Luminescence-Detection Hybrid Device With Photodiode and Organic Light-Emitting Diode,” IEEE, Elect. Dev. Letters 27, pp. 746-748 (2006), an integrated element for detecting bioluminesence is disclosed. However, the photodiode used is mainly made up of silicon, and on silicon is deposited a low-molecular, light-emitting layer, which couples with the introduction of a fluid through a microfluidic tube to achieve the purpose of detection. Various complex processes for fabricating a photomask, such as doping of inorganic semiconductor and optical lithography and etching, cannot be avoided. The aforesaid device still focuses primarily on studies on microfluidic tubes for introduction of fluids, and is limited to the purpose of detection. Thus, a function like real-time detection of biological substances cannot be obtained.

In “Integrated thin-film polymer/fullerene photodetectors for on-chip microfluidic chemiluminescence detection,” Lab on a Chip 7, 58 (2007), a microfluidic system is disclosed. Although a photodiode is used as an integrated element for detecting bioluminesence, the photodiode uses spin coating of an organic polymer, instead of deposition of a low-molecular polymer, to form an active layer.

In “Monolithically integrated dye-doped PDNS long-pass filters for disposable on-chip luminescence detection,” Lab on a Chip 6, 981(2006), a concept of an organic light-emitting source and an organic photodiode is disclosed. Although the material used is an organic material, there is no concept of an integrated element. Specifically, a sample fluid is placed in an organic light-emitting diode and an organic photodiode, and the step still uses the microfluidic technology and cannot perform real-time biological detections.

Therefore, an urgent issue to be solved here to provide a biosensor, which can solve problems like high prices and bulky volumes and incapability to perform real-time measurement without using microfluidic tubes primarily for introductions of fluids, and avoid doping of an inorganic semiconductor and performing various complex processes like optical lithography and etching. Further, the biosensor should be a wholly organic integrated detecting element, which can perform real-time biological detections, without applying the microfluidic technology. In other words, the real-time biological detections can be performed by simply placing the biosensor close to samples.

### SUMMARY OF THE INVENTION

In view of the forgoing problems, the present invention provides a biosensor, which is a solid-state element capable of performing detections in an aqueous environment. The biosensor comprises a light-emitting diode for emitting rays of light after receiving bias; a bio sensing layer for absorbing the rays of light emitted by the light-emitting diode to generate fluorescence, the biosensing layer causes changes in the light-emitting property thereof after absorbing, adsorbing and/or bonding with a biological substance (i.e., messenger molecule) released during in vivo signal transduction in an organism, and the biosensing layer comprises a biosensor molecule that is selected from materials having specificity to the messenger molecule; and a photodiode for absorbing the fluorescence generated by the biosensing layer and converting the fluorescence into interpretable information.

In a preferred embodiment, the light-emitting diode of the biosensor is an organic light-emitting diode, and the photodiode is an organic photodiode.

In another preferred embodiment, the light-emitting diode may further comprise an external signal source for receiving a modulating signal, so as to allow the interpretable information converted by the photodiode to be modulated.

On the other hand, in another aspect, the biosensor may further comprise a first transparent substrate, which is disposed between the biosensing layer and the light-emitting diode. The biosensor molecule of the biosensing layer is formed on the first transparent substrate. Optionally, the biosensor may further comprise a filter, which is disposed between the light-emitting diode and the photodiode, for blocking the rays of light emitted from the light-emitting diode. In a preferred embodiment of the biosensor comprising the filter, the biosensor may comprise a first transparent substrate.

The filter of the present invention can be prepared from any suitable materials. More specifically, the filter may be prepared, for example, from a small-molecular organic material or an organic polymer, but is not limited thereto. The filter prepared should be able to sufficiently block or filter the rays of light emitted by the light-emitting diode or other background light.

Moreover, in a preferred embodiment of the biosensor comprising the filter, the biosensor may further comprise a second transparent substrate, which is disposed between the light-emitting diode and the filter.

In another preferred embodiment, the biosensor may further comprise a third transparent substrate, which is disposed between the filter and the light-emitting diode.

In a further aspect, the present invention further provides a method for detecting a biological signal, comprising the steps of: providing a biosensor molecule and detecting the fluorescence emitted by the molecule; providing a biological sample that releases a messenger molecule; allowing the biological sample to be in contact with the biosensor molecule, wherein the biosensor molecule is selected from materials having specificity to the messenger molecule; and measuring the change in the fluorescence after the biosensor molecule is in contact with the biological sample and converting the fluorescence into interpretable information.

In a preferred embodiment of the method, the biosensor molecule provided by the biosensor of the present invention is used as a biosensor molecule during the measurement.

The biosensor of the present invention is applied in a aqueous environment. The biosensor integrates the biosensing layer, the light-emitting diode and the photodiode, wherein the biosensor molecule of the biosensing layer has specificity to the messenger molecule to be assayed, the biosensing layer causes the light-emitting property thereof to change after absorbing, adsorbing and/or bonding with the messenger molecule, and the rays of light generated by excitation of the light-emitting diode causes fluorescence to be emitted by the biosensing layer. After the fluorescence is absorbed by the photodiode, it can be converted into interpretable information, such as a photocurrent signal, fluorescence magnitude, etc. Then, the meaning of the in vivo signal transduction in an organism can be understood by interpreting the photocurrent signal. The information to be interpreted can be rapidly obtained by using the biosensor of the present invention, and thus the biosensor of the present invention has the advantage of real-time detection.

### BRIEF DESCRIPTION OF THE DRAWINGS

FIG. 1 shows a schematic diagram of a biosensor according to an embodiment of the present invention;

FIG. 2 shows a schematic diagram of a biosensor according to another embodiment of the present invention;

FIG. 3 shows a photoluminescence spectrum obtained by measuring a biosensing layer according to the present invention, wherein the biosensing layer is in contact with a predetermined amount of SNAP;

FIG. 4 shows a spectrum of different fluorescence magnitudes of a biosensing layer in solutions with different pH values according to the present invention;

FIG. 5 shows a photoluminescence spectrum depicting the effect of NAP on the biosensing layer according to the present invention;

FIG. 6 shows a SEM diagram of a biosensing layer with a fibrous structure according to the present invention; and

FIG. 7 shows a photoluminescence spectrum of the biosensing layer with a fibrous structure according to the present invention.

### DETAILED DESCRIPTION OF THE INVENTION

The specific preferred embodiments below are used for illustrating the detailed description of the present invention. Persons having ordinary skills in the art can easily conceive the other advantages and effects of the present invention based on the disclosure of the specification.

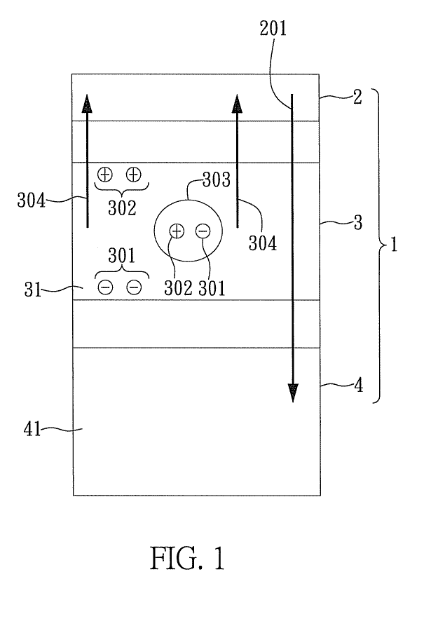

FIG. 1 is a schematic diagram of the biosensor of the present invention, for illustrating the components of the biosensor of the present invention. As shown in FIG. 1, a biosensor 1 of the present invention at least comprises a biosensing layer 2, a light-emitting diode 3 and a photodiode 4.

For example, the biosensing layer 2 has a biosensor molecule for absorbing, adsorbing and/or bonding with a messenger molecule released from a biological sample, and absorbing the rays of light emitted by the light-emitting diode 3 to generated fluorescence 201. The biosensor molecule is selected from materials having specificity to the messenger molecule. In a practical implementation, the materials needed may be selected according to the detecting and sensing purposes. For example, if a biological sample that releases nitric oxide is to be examined, a compound represented by formula (I) may be selected as the biosensor molecule in the biosensing layer 2. The compound forms a weak bond with nitric oxide, thereby affecting absorption (by the compound) of the fluorescence further generated by the rays of light emitted by light-emitting diode.

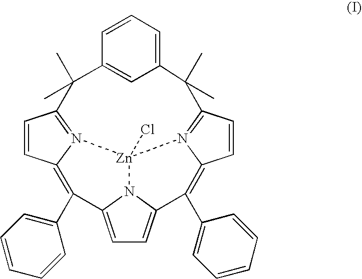

Moreover, not bonding to any theories, selection conditions of a biosensor molecule typically include the ability to absorb external energy such as luminescence energy and the further generation of fluorescence by the biosensor molecule after absorbing the energy. Next, to avoid discrepancies in the test results, selection conditions of a biosensing molecule also includes specificity to a messenger molecule, so as to obtain correct results. As such, the biosensor molecule usually can have a conjugative structure with an appropriate length to emit fluorescence after absorption of energy, and have a position or a functional group that can bind with the messenger molecule to be tested to change the wavelength or magnitude of the fluorescence after absorbing, adsorbing and/or bonding with the messenger molecule. Therefore, in a preferred embodiment, the present invention is illustrated using the compound represented by formula (I), but is not limited thereto.

The light-emitting diode 3 may be, for example, an organic light-emitting diode or others having equivalent affects. If the light-emitting diode 3 is an organic light-emitting diode, the material for fabricating the light-emitting diode 3 is selected from organic light-emitting materials. The materials may comprise singlet or triplet materials in the form of an element comprising a mono-layered membrane or a multi-layered membrane. The photodiode 4 may be, for example, an organic photodiode made of an organic light-emitting material. The materials may comprise a singlet or triplet material in the form of a mono-layered membrane or a multi-layered membrane. The singlet or triplet material may also be in the form of a membrane prepared from doped substances or a single substance. Further, the membrane may be doped with inorganic substances.

In a preferred embodiment, the biosensor 1 comprising the light-emitting diode 3 and the photodiode 4 can be an integrated element having a multi-layered membrane formed using membrane-forming processes like deposition, spin coating or spray coating.

The light-emitting diode 3 applies bias on both ends thereof, and electrons 301 are injected from a cathode (not shown), and holes 302 are injected from an anode (not shown) to recombine in a polymeric material 31 of the light-emitting diode 3 to generate excitons 303, which release energy in the form of rays of light 304.

As shown in FIG. 1, the biosensing layer 2 causes the light-emitting property thereof to change after absorbing and/or adsorbing the messenger molecule released from the biological sample. Specifically, the rays of light 304 generated by excitation of the light-emitting diode 3 cause the wavelength or magnitude of fluorescence 201 emitted from the biosensing layer 2 to change. After the changed fluorescence 201 is absorbed by the photodiode 4, the fluorescence 201 is converted into an interpretable photocurrent signal (not shown). Then, the meaning of the in vivo signal transduction in the organism can be understood by interpreting the photocurrent signal.

A polymeric photodiode is used as an example of the photodiode 4. The operation of the polymeric photodiode is to form excitons (not shown) after a polymeric material 41 absorbs the fluorescence 201, performs separation of carriers at different material interfaces to generate electrons and holes (not shown), and uses Vbias to collect the carriers, thereby generating a photocurrent with a photocurrent value displayed on a electric meter. Then, an analysis of the photocurrent value is performed.

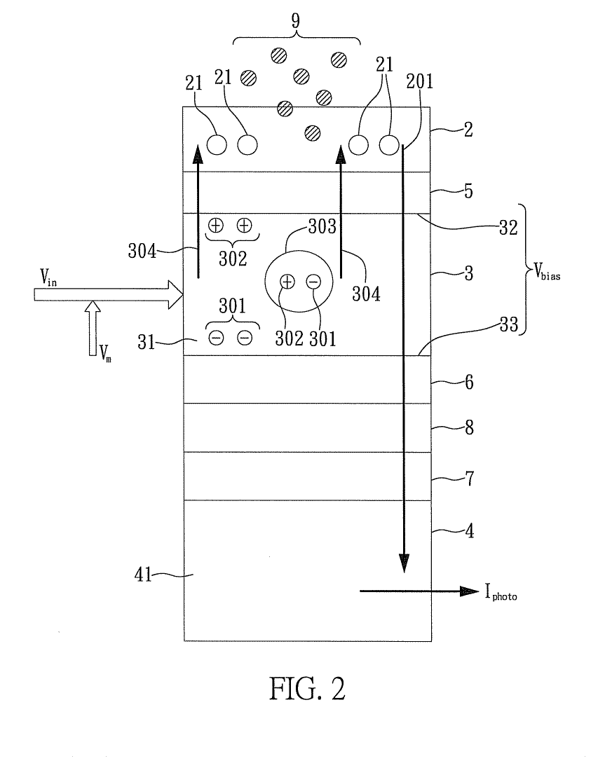

FIG. 2 is a schematic diagram of another preferred embodiment, for illustrating the biosensor of the present invention. As shown in FIG. 2, the biosensor 1 of the present invention comprises the biosensing layer 2, the light-emitting diode 3, the photodiode 4, a first transparent substrate 5, a second transparent substrate 6, a third transparent substrate 7 and a filter 8.

For example, the biosensing layer 2 may comprise a biosensor molecule and a substrate material such as a polymer. The biosensing layer 2 is obtained by applying spin coating or electrospinning techniques to a mixture of the biosensor molecule 21 and the substrate material on the first transparent substrate 5 disposed on the light-emitting diode 3. Referring again to FIG. 2, the first transparent substrate 5 is disposed between the biosensing layer 2 and the light-emitting diode 3, and the filter 8 is disposed between the light-emitting diode 3 and the photodiode 4, for separating the light-emitting diode 3 and the photodiode 4 and blocking the effects of the light-emitting diode 3 and the background light.

In another preferred embodiment, the biosensor may further comprise the second transparent substrate 6, which is disposed between the light-emitting diode 3 and the filter 8. In a further preferred embodiment, the biosensor may further comprise the third transparent substrate 7, which is disposed between the filter 8 and the photodiode 4.

In the present invention, the filter can be prepared from any suitable materials. More specifically, the filter can be made, for example of an organic material such as a small-molecular organic material or an organic polymer, but is not limited thereto. The filter prepared should be able to sufficiently block or filter the rays of light emitted by the light-emitting diode or other background light. Examples of the materials for preparing the transparent substrates may include, but not limited to, transparent materials such as glass or polymers.

A polymeric light-emitting diode is used as an example of the light-emitting diode 3, which comprises an anode 32 and a cathode 33, with Vbias, on both ends thereof. The electrons 301 are injected from the cathode 33, and the holes 302 are injected from the anode 32 to recombine in the polymeric material 31 of the light-emitting diode 3 to generate excitons 303, which release energy in the form of rays of light 303.

As mentioned previously, the biosensing layer 2 causes changes in the light-emitting property thereof after absorbing and/or adsorbing a biological substance 9 released during an in vivo signal transduction an in organism. That is, the rays of light 304 generated by excitation of the light-emitting diode 3 cause a change in the wavelength or magnitude of fluorescence 201 emitted by the biosensing layer 2. After the changed fluorescence 201 is absorbed by the photodiode 4, the fluorescence 201 is converted into an interpretable photocurrent signal (not shown). Then, the meaning of the in vivo signal transduction in the organism can be understood by interpreting the photocurrent signal.

Using a polymeric photodiode as an example of the photodiode 4 shown in FIG. 2, the operation of the polymeric photodiode is to form excitons (not shown) after a polymeric material 41 absorbs the fluorescence 201, performs separation of carriers at different material interfaces to generate electrons and holes (not shown), and uses Vbias to collect the carriers, thereby generating a photocurrent Iphoto with a photocurrent value displayed on a electric meter. Then, an analysis of the photocurrent value is performed.

Applying a modulating signal (Vm) on an external signal source (Vin) inputted by the light-emitting diode 3 causes the external signal source to have a modulating signal. In this case, the photocurrent signal received by the photodiode 4 is also modulated. Thus, it is extremely convenient to perform signal analysis and output/input.

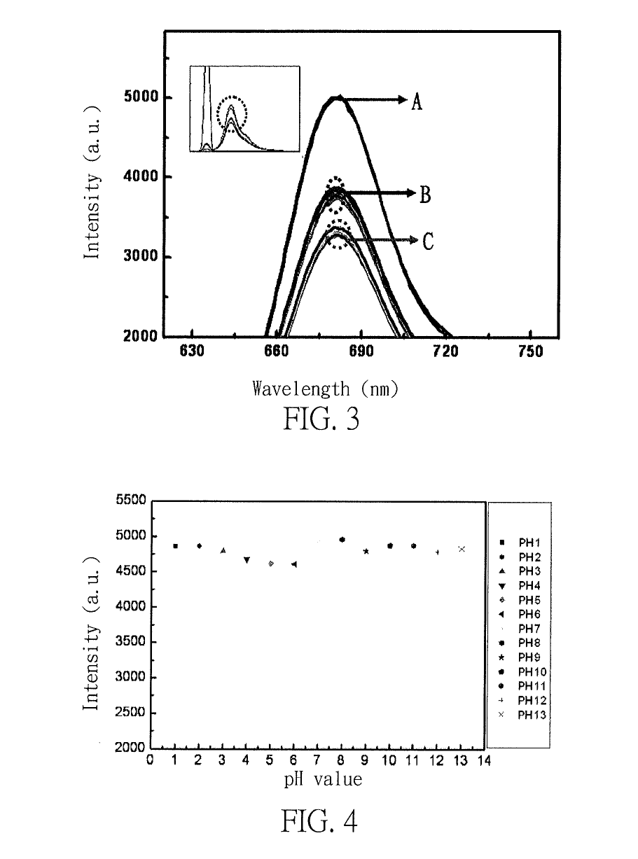

Referring further to FIG. 3, it shows a test result of the biosensor of the present invention. In this embodiment, a mixture of the compound represented by formula (I) and poly(methyl methacrylate) is used to form a bio sensing layer. The specific method for preparing the biosensing layer comprises the steps of dissolving the compound represented by formula (I) and PMMA in a toluene solvent at a weight ratio of 1:80, and then spin coating the mixture to form a biosensing layer, or the steps of dissolving the compound represented by formula (I) and PAN in a dimethyl sulfoxide solvent at a weight ratio of 1:25, and then electrospinning the mixture to form a biosensing film. Subsequently, the aforesaid steps are repeated to obtain the biosensor of the present invention.

The biosensor of the present invention is disposed in a quartz tank, following by the steps of adding dropwisely a predetermined concentration of S-nitoso-N-acetylpenicillamine (SNAP) that releases nitric oxide onto the biosensor, and observing optical changes. As shown in FIG. 3, the biosensor layer is prepared by direct dropwise addition of SNAP. Symbol A indicates the stable fluorescence magnitude before the addition of SNAP, symbol B indicates the photoluminescence spectrum obtained by measurement after adding dropwisely 0.017M of SNAP, and symbol C indicates the photoluminescence spectrum obtained by measurement after adding dropwisely 0.025M of SNAP. It can be seen obviously from FIG. 3 that the fluorescence magnitude decreased with increasing SNAP concentrations, and the fluorescence spectra respectively indicated by symbols B and C continued to decrease over time.

Referring to FIG. 4, it shows the effects of solutions with different pH values to the fluorescence magnitude of a biosensing layer. Since SNAP dissolved in water was acidic, the pH values of the solutions were changed and the magnitude of the fluorescence emitted by the biosensing layer was measured. It is known from FIG. 4 that the magnitude of the fluorescence emitted by the biosensing layer did not obviously change with different pH values of the solutions.

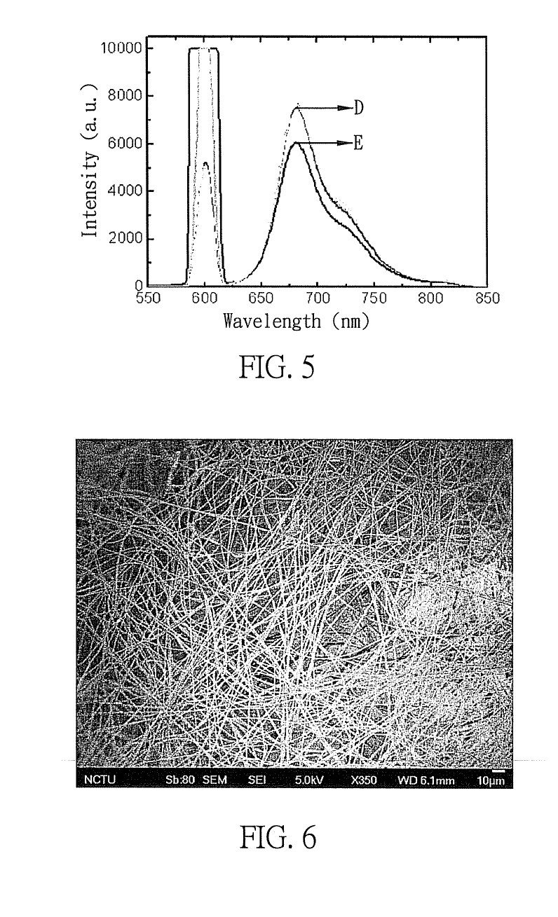

Referring to FIG. 5, it shows the effects of N-acetyl penicilliamine (NAP) on the fluorescence magnitude of a biosensing layer. NAP is the residue after nitric oxide is released from SNAP. It can be seen from FIG. 5 that by comparing with the fluorescence magnitude when no SNAP is added (as indicated by symbol E), the fluorescence magnitude in the photoluminescence spectrum after further adding 0.05 M of NAP (as indicated by symbol D) did not decrease as NAP was added. It is known from the above that the decrease in the biosensing layer was not caused by the presence of NAP.

Referring to FIG. 6, it discloses a SEM diagram of another biosensing layer, which has a fibrous structure. Different from the aforesaid biosensing layer formed by spin coating, a biosensing layer with a fibrous-structured film in this embodiment is formed by electrospinning. This type of fibrous structure has a substantially increased surface area for being in contact or reacting with a messenger molecule, so as to decrease the reaction time of an element and subsequently increases its efficiency. In this embodiment, the compound represented by formula (I) is dissolved in a polyacrylonitrile solution. For example, 1 g of the compound represented by formula (I) is dissolved in 250 g of 10 wt % of polyacrlonitrile solution, and a biosensing layer with a wick structure is formed by electrospinning. Then, the biosensor of the present invention is obtained by repeating the aforesaid method. Further, the present invention uses conventional electrospinning, and therefore details of electrospinning is not described herein.

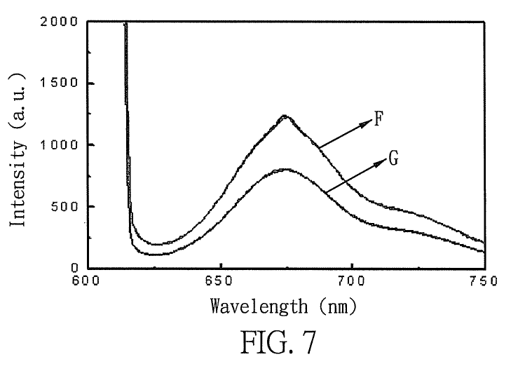

As described in the aforesaid method, the result obtained after the biosensing layer and SNAP releases nitric oxide was measured, wherein 1 ml of 0.05M of SNAP was added in a quartz tank. As shown in FIG. 7, symbol F indicates the fluorescence magnitude before adding SNAP, and symbol G indicates the fluorescence magnitude 10 minutes after adding SNAP. After the addition of SNAP, the fluorescence magnitude rapidly decreased but still maintained the same magnitude 10 minutes later. It can be seen from the above that the fibrous structure of the biosensing layer allowed it to rapidly reach saturation after reaction with nitric oxide, thereby increasing the efficiency of the biosensor.

In light of the above embodiments, the biosensor of the present invention can be applied in a aqueous environment suitable for biosensing. The biosensor of the present invention further possesses the following advantages:

1. Problems like inertness to external affects and overly high operating voltages of an organic field-effect transistor can be solved. Further, problems like high prices, bulky volumes and incapability for performing real-time measurement are resolved.

2. Complex processes such as doping of inorganic semiconductor and optical lithography and etching can be avoided.

3. The biosensor is a wholly organic integrated detection element, and can achieve real-time biosensing effects simply by placing the biosensor close to a sample without using microfluidic tubes to introduce fluids.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A biosensor, comprising:
a light-emitting diode for emitting rays of light after receiving a bias;
a biosensing layer having a biosensor molecule for absorbing, adsorbing and/or bonding with a messenger molecule released by a biological sample, and absorbing the rays of light emitted by the light-emitting diode to generate fluorescence, in which the biosensor molecule is selected from materials having specificity to the messenger molecule; and a photodiode for absorbing the fluorescence generated by the biosensing layer and converting the fluorescence into interpretable information.

2. The biosensor of claim 1, wherein the light-emitting diode is either an organic light-emitting diode or an inorganic light-emitting diode.

3. The biosensor of claim 1, wherein the photodiode is either an organic photodiode or an inorganic photodiode.

4. The biosensor of claim 1, wherein the light-emitting diode further comprises an external signal source for receiving a modulating signal, so as to allow the interpretable information converted by the photodiode to be modulated.

5. The biosensor of claim 1, further comprising a first transparent substrate disposed between the biosensing layer and the light-emitting diode, and the biosensor molecule of the biosensing layer is formed on the first transparent substrate.

6. The biosensor of claim 1, further comprising a filter disposed between the light-emitting diode and the photodiode, and is used for blocking the rays of light emitted by the light-emitting diode.

7. The biosensor of claim 5, further comprising a filter disposed between the light-emitting diode and the photodiode, and is used for blocking the rays of light emitted by the light-emitting diode.

8. The biosensor of claim 6, wherein the filter is made of a small-molecular organic material or an organic polymer.

9. The biosensor of claim 7, wherein the filter is made of a small-molecular organic material or an organic polymer.

10. The biosensor of claim 6, further comprising a second transparent substrate disposed between the light-emitting diode and the filter.

11. The biosensor of claim 7, further comprising a second transparent substrate disposed between the light-emitting diode and the filter.

12. The biosensor of claim 10, further comprising a third transparent substrate disposed
between the filter and the photodiode.

13. The biosensor of claim 11, further comprising a third transparent substrate disposed between the filter and the photodiode.

14. The biosensor of claim 1, wherein the biosensing layer is a film with a fibrous structure.

15. The biosensor of claim 1, wherein the biosensor molecule of the biosensing layer has a structure represented by formula (I):

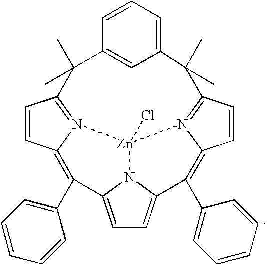

16. The biosensor of claim 14, wherein the biosensor molecule of the biosensing layer has a structure represented by formula (I):

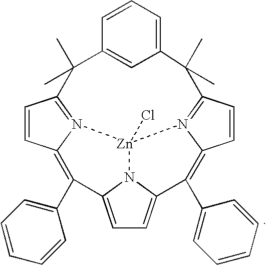

17. A method for detecting a biological signal, comprising:
providing a biosensor molecule and measuring fluorescence emitted by the biosensor molecule;
providing a biological sample, wherein the biological sample releases a messenger molecule;
allowing the biological sample to be in contact with the biosensor molecule, wherein the biosensor molecule is selected from materials having specificity to the messenger molecule; and
measuring a change generated in the fluorescence after the biosensor molecule is in contact with the biological sample, and converting the fluorescence into interpretable information.

18. The method of claim 17, wherein the biosensor molecule is a biosensor molecule provided by a biosensor according to claim 1.

19. The method of claim 17, wherein the biosensor molecule is a biosensor molecule provided by a biosensor according to claim 14.

20. The method of claim 17, wherein the biosensor molecule is a biosensor molecule provided by a biosensor according to claim 16.
